(19) United States
(12) Patent Application Publication
(10) Pub. No.: US 2025/0072336 A1
(43) Pub. Date: Mar. 6, 2025

(54) Modular Prefabricated Raised Bed Greenhouse

(71) Applicant: SOLAI, Inc., Reno, NV (US)

(72) Inventor: Josh Smith, Reno, NV (US)

(21) Appl. No.: 18/827,584

(22) Filed: Sep. 6, 2024

Related U.S. Application Data
(60) Provisional application No. 63/580,767, filed on Sep. 6, 2023.

(51) Int. Cl. A01G 9/14; E04B 1/343

(52) U.S. Cl. CPC A01G 9/14; E04B 1/34321

(57) ABSTRACT

Modular prefabricated raised bed greenhouses having side panels, end panels, and roof panels are described. The side panels, end panels, and roof panels each define one or more open spaces covered by a transparent sheet. The side panels have a bottom frame and a top frame that join at an angle. The end panels have a bottom frame and a top frame that join at a zero angle to form a planar surface. Pairs of side panels can be adjacently coupled together to extend the length of the raised bed greenhouse. An end panel is coupled to the pair of side panels on each end of the raised bed greenhouse. A roof panel is coupled with each pair of side panels to form a roof. Each side panel has a door that transitions between an open and closed position for accessing the inside of the raised bed greenhouse.

### FIELD OF THE INVENTION

The field of the invention is modular prefabricated raised bed greenhouses.

### BACKGROUND

The background description includes information that may be useful in understanding the present invention. It is not an admission that any of the information provided herein is prior art or relevant to the presently claimed invention, or that any publication specifically or implicitly referenced is prior art.

Greenhouses are a great way to regulate climate conditions, such as temperature and humidity, for growing plants. Greenhouses are made of transparent materials to capture light and heat from the sun. Greenhouses can be made in many different sizes to accommodate different plants and different growing techniques. Raised bed greenhouses are used for raised bed gardening, in which the soil is raised above ground level. Raised bed gardening can help to reduce weeds, prevents the soil from being walked on and compacted, and reduces the amount of bending over and crouching when harvesting and/or caring for the plants.

Various greenhouses for raised bed gardening are known. See, for example, AT511450A4, AU2013100358A4, U.S. Pat. No. 6,434,882B1, U.S. Pat. No. 9,173,352B1, US20160316637A1, US20170280635A1, US20220369573A1, and DE102019105187A1. Also see, https://eartheasy.com/cedar-complete-raised-garden-bed-kit-with-greenhouse-cover-8-x-8/, https://freshpatio.com/raised-garden-bed-greenhouse-plans/, and https://www.homedepot.com/p/BACKYARD-EXPRESSIONS-PATIO-HOME-GARDEN-Large-36-in-x-24-in-Tan-Wood-Raised-Planter-Box-with-Greenhouse-906533/323830732. While advantageous in some regards, these existing raised bed greenhouses suffer from one or more disadvantages such as being overly complicated to manufacture and/or assemble, costly, heavy, and non-customizable.

Thus, there remains a need for an improved modular prefabricated raised bed greenhouse that is economical, light weight, structurally simple and strong, easy to ship and assemble, and customizable.

### SUMMARY OF THE INVENTION

The inventive subject matter provides apparatus, systems, and methods in which a modular raised bed greenhouse is assembled using prefabricated side panels, end panels, and roof panels. The side panels and end panels each comprise a base frame that defines one or more open spaces covered by a transparent sheet, and a top frame that defines one or more open spaces covered by a transparent sheet. The base frame and the top frame of the side panel are joined at an angle so that the top of the raised bed greenhouse is angled inward. In some embodiments, the angle is about 72 degrees. The base frame and the top frame of the end panel are not joined at an angle and instead form a planar surface. The roof panel comprises a roof frame that defines one or more open spaces covered by a transparent sheet. A door is disposed in or on the top frame and is transitionable between an open position and a closed position. The door can be hingeably or slidably coupled with the top frame. The one or more open spaces of the side panel's base frame can alternatively be covered with a non-transparent sheet.

The side panels have one or more fasteners for adjacently coupling multiple side panels together and/or for coupling with an end panel. In some embodiments, the fasteners are mechanical fasteners (e.g., bolts/nuts, screws, clamps, latch/lock mechanisms, etc.).

In one aspect, the base frame and the top frame of side panels and end panels, and the roof frame, can each comprise a plurality of tubing joined together to form the one or more open spaces. The tubing can be permanently joined together such as by welding, or alternatively, can be removably joined together such as by mechanical fasteners. The top frame of the side panels preferably defines an uncovered open space that serves as an air vent.

Each side panel, end panel, and roof panel are preassembled and/or prefabricated as modular units. The side panels, end panels, and roof panels can be prefabricated at a first location (e.g., workshop, manufacturing facility) and shipped to a second location (e.g., customer, purchaser) for final assembly of the complete raised bed greenhouse. The side panels are preferably stackable with one another, the end panels are preferably stackable with one another, and the roof panels are preferably stackable with one another, for ease of shipping.

The side panels are configured to adjacently attach with either another side panel or an end panel. The roof panels are configured to adjacently attach with either another roof panel or an end panel. In this manner, the final assembled raised bed greenhouse can comprise different dimensional configurations, such as one pair of end panels, one pair of side panels, and a roof panel (1×1), one pair of end panels, two pairs of side panels, two roof panels (1×2), or one pair of end panels, any number of pairs of side panels, and any equal number of roof panels (1×n), depending on the needs and space constraints of the customer. Each end panel in a pair is disposed on opposing sides of the raised bed greenhouse from one another. Each side panel in a pair is disposed on opposing sides of the raised bed greenhouse from one another. Each roof panel is disposed between the two side panels in a pair.

In other embodiments, a modular prefabricated raised bed greenhouse comprises a first side panel and a second side panel disposed on opposite sides of the modular prefabricated raised bed greenhouse, wherein the first side panel has a base frame and a top frame that form an angle, and wherein the second side panel has a base frame and a top frame that form a planar surface. The modular prefabricated raised bed greenhouse also comprises a first end panel and a second end panel disposed on opposite sides of the modular prefabricated raised bed greenhouse and coupled with the first side panel and the second side panel, wherein the first end panel and second end panel are identical. The modular prefabricated raised bed greenhouse also comprises a roof panel coupled with the first side panel, the second side panel, the first end panel, and the send end panel for 1×1 configuration. Alternatively, the modular prefabricated raised bed greenhouse can comprise n number of adjacently attached roof panels and n number of adjacently attached pairs of first and second side panels for a 1×n configuration.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is a front perspective view of a modular raised bed greenhouse.

FIG. 2 is an exploded front perspective view of the modular raised bed greenhouse of FIG. 1.

FIG. 3 is an exploded front perspective view of the modular raised bed greenhouse of FIG. 1 with additional modules added to extend the length of the raised bed greenhouse.

FIG. 4 is a front view of the end panel of the modular raised bed greenhouse of FIG. 1.

FIG. 5 is an exploded front view of the end panel of FIG. 4.

FIG. 6 is a front view of the side panel of the modular raised bed greenhouse of FIG. 1.

FIG. 7 is a front view of the door frame and door of the side panel of FIG. 6.

FIG. 8 is a perspective view of the door frame of the side panel of FIG. 6.

FIG. 9 is a perspective view of the door of the side panel of FIG. 6.

FIG. 10 is a perspective view of another embodiment of a modular raised bed greenhouse.

### DETAILED DESCRIPTION

The following discussion provides many example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

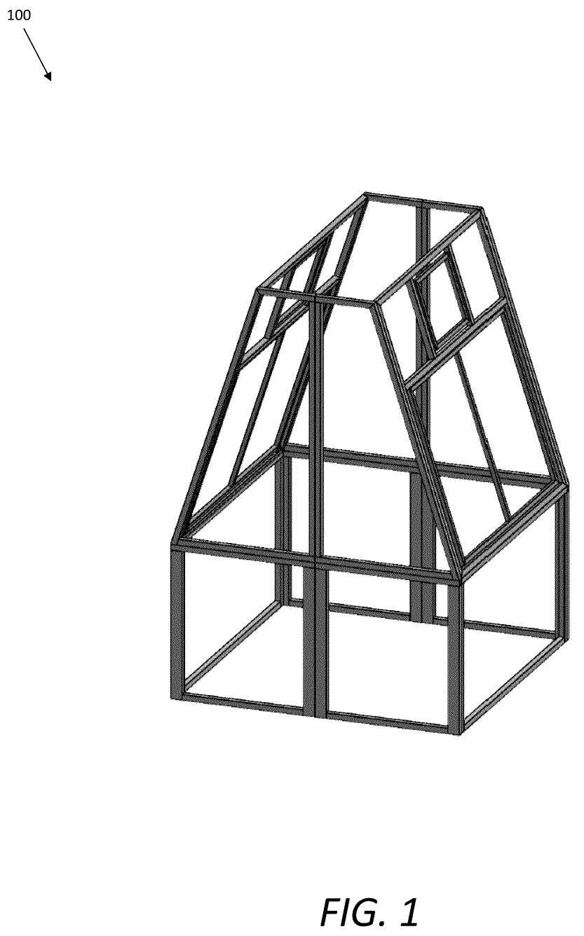

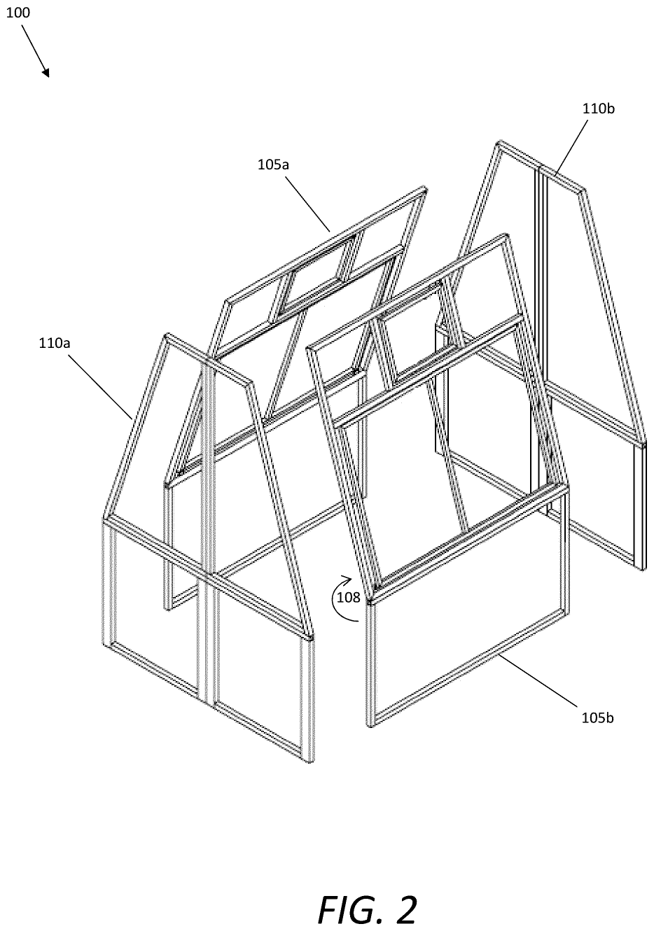

FIG. 1 shows a perspective view of a modular prefabricated raised bed greenhouse 100, which has a 1×1 configuration (one pair of end panels, one pair of side panels, and a roof panel). FIG. 2 shows an exploded perspective view of modular prefabricated raised bed greenhouse 100. Raised bed greenhouse 100 has a first side panel 105a, a second side panel 105b, a first end panel 110a, a second end panel 110b, and a roof panel (not shown). Side panels 105a, 105b are identical parts. End panels 110a, 110b are identical parts. Side panels 105a, 105b and end panels 110a, 110b are comprised of frameworks that define one or more open spaces covered by transparent, semi-transparent, and/or non-transparent sheets.

Side panels 105a, 105b, end panels 110a, 110b, and the roof panel are prefabricated and preassembled at a first location (e.g., workshop, manufacturing facility) and shipped to a second location (e.g., customer, purchaser) for final assembly of raised bed greenhouse 100. Side panels 105a, 105b are preferably stackable with one another, end panels 110a, 110b are preferably stackable with one another, and multiple roof panels are preferably stackable with one another, for ease of shipping. Raised bed greenhouse 100 includes one or more fasteners for coupling side panels 105a, 105b, end panels 110a, 110b, and roof panels together. The same fasteners (e.g., holes, screws, clamps, latching mechanisms, locking mechanisms, etc) can be used to couple the side panel with either an adjacent side panel or with an end panel. The location of the attachment points on each side of the side panel match each other. In addition, the location of attachment points on each side of the end panel match each other, which also match with the location of the attachment points on each side of the side panel. In this manner, the side panels, end panels, and roof panels can be used to create different dimensional configurations (1×1, 1×2, 1×n) based on the needs and space constraints of the user.

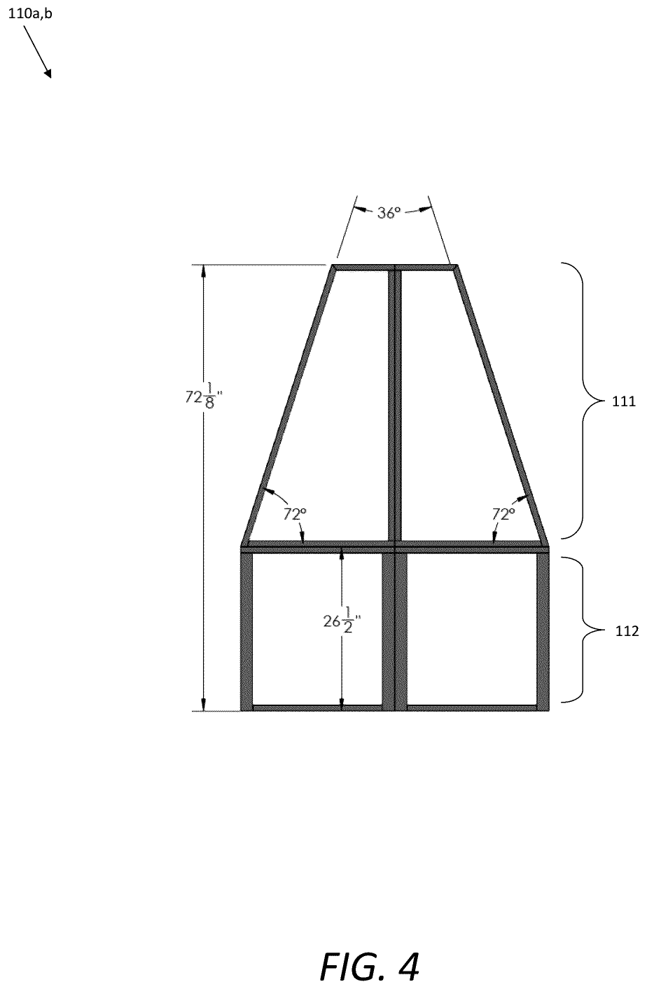

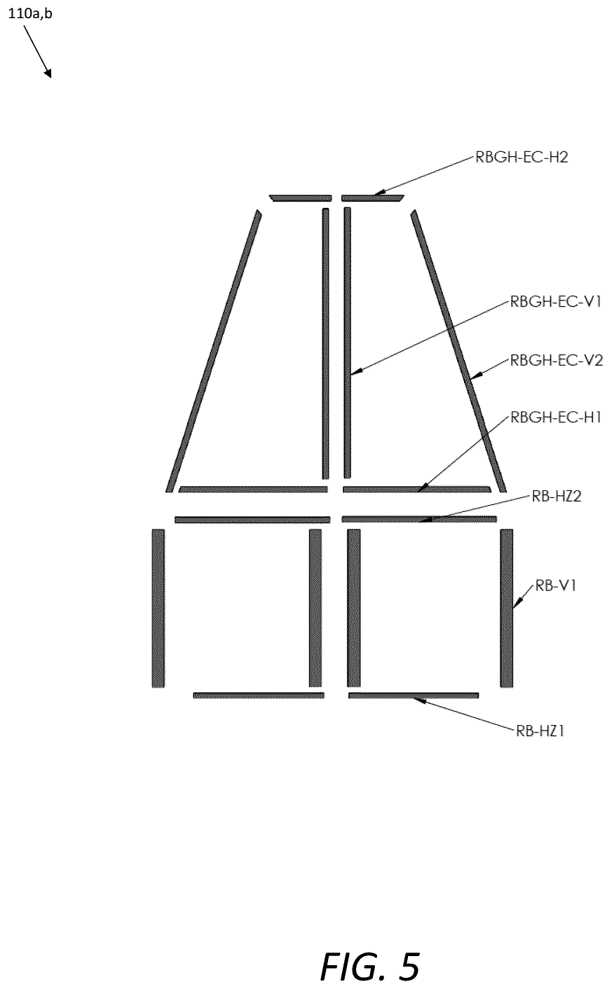

A front view of end panels 110a, 110b is shown in FIG. 4. A front exploded view of end panels 110a, 110b is shown in FIG. 5. End panels 110a, 110b comprise a top frame 111 coupled with a base frame 112 at an angle of zero such that they form a planar surface.

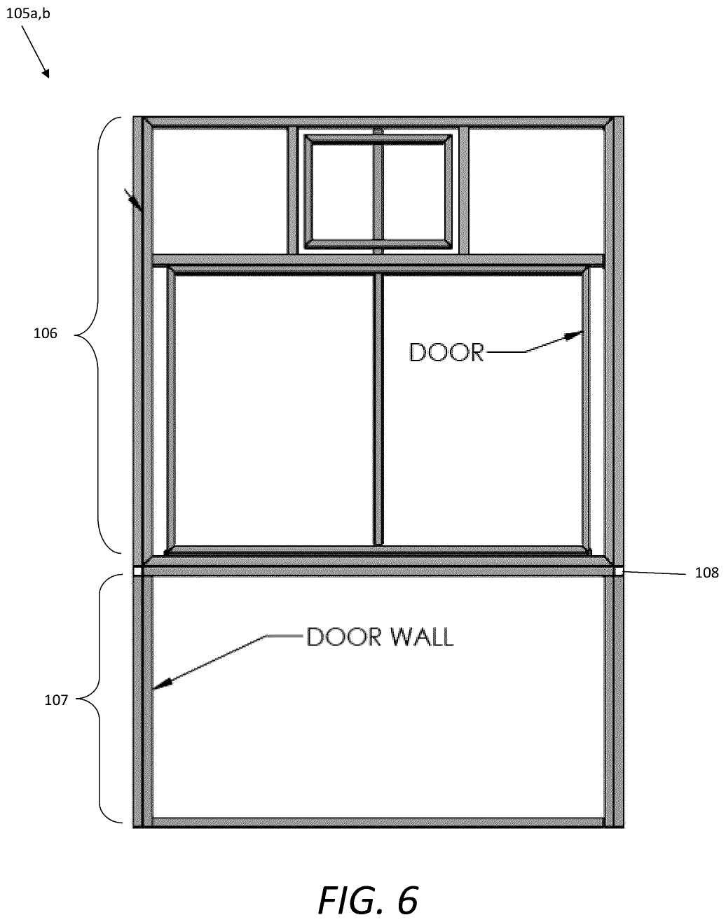

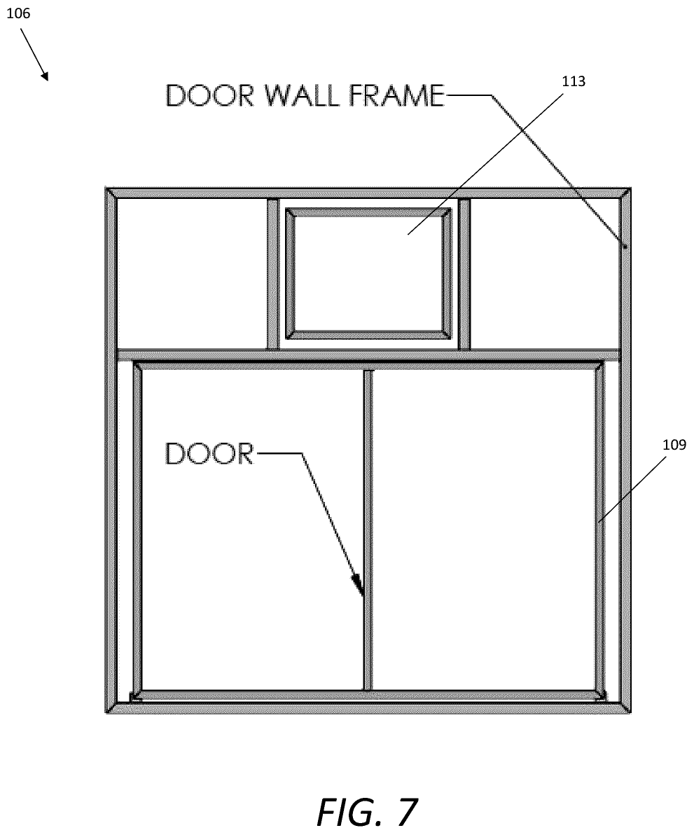

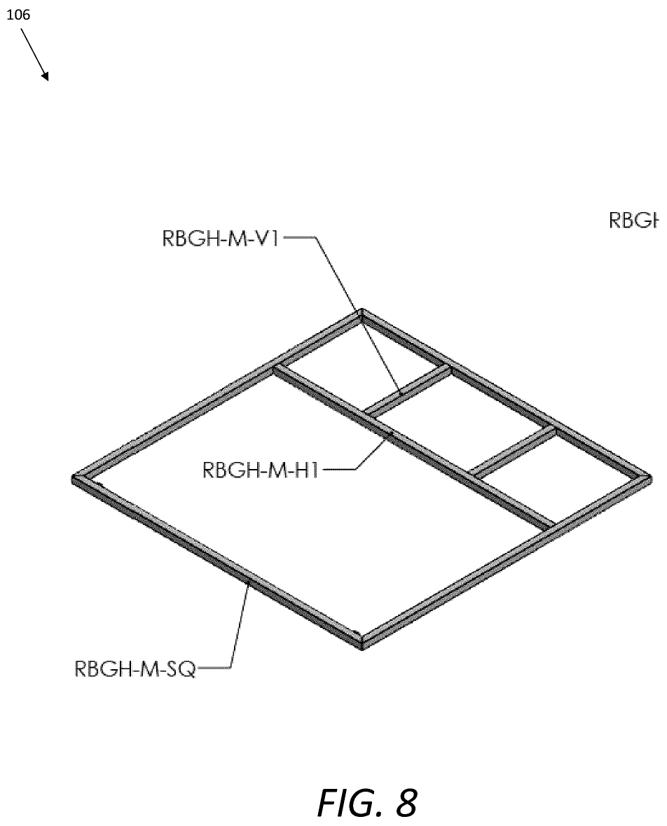

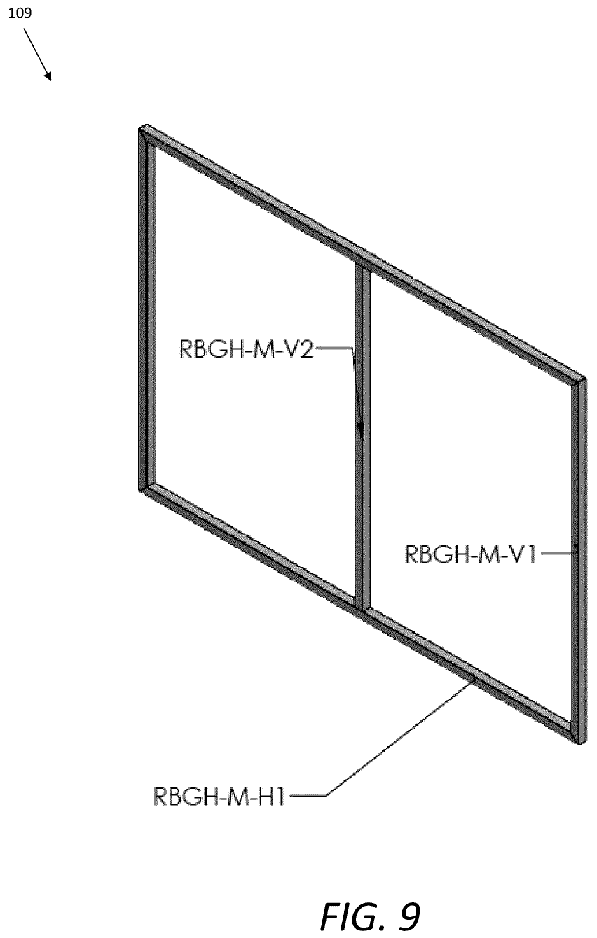

A front view of side panels 105a, 105b is shown in FIG. 6. Side panels 105a, 105b comprise a top frame 106 coupled with a base frame 107 at an angle 108. A front view of top frame 106 removed from base frame 107 is shown in FIG. 7. Top frame 106 has a door 109 and an uncovered vent 113. FIG. 8 shows a perspective view of top frame 106 with door 109 and vent 113 removed. FIG. 9 shows a perspective view of door 109. Door 109 movably couples with top frame 106 and is transitionable between an open and closed position. Door 109 can be hingeably or slidably coupled with top frame 106. It is also contemplated that door 109 can open inward, outward, sideways, up, down, at an angle, or any other configuration (e.g., French doors, scissor doors, etc.).

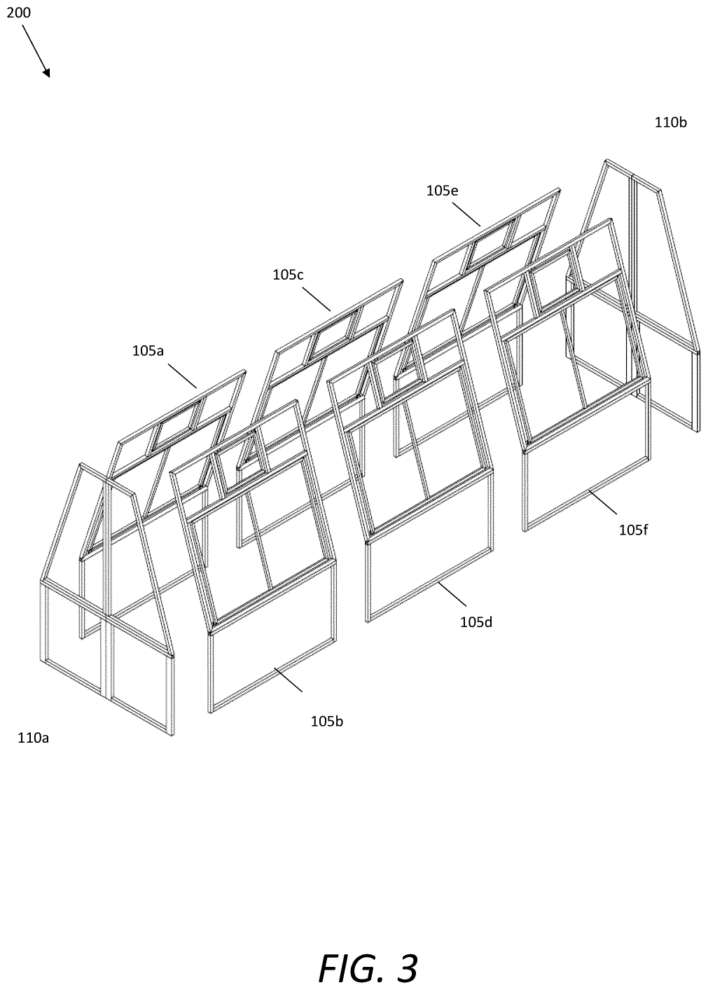

FIG. 3 shows a perspective view of a modular prefabricated raised bed greenhouse 200, which has a 1×3 configuration (one pair of end panels, three pairs of side panels, three roof panels). Each end panel in a pair is disposed on opposing sides of raised bed greenhouse 200 from one another. Each side panel in a pair is disposed on opposing sides of raised bed greenhouse 200 from one another. Each roof panel is disposed between the two side panels in a pair. The length of raised bed greenhouse 200 can be modified and selected according to the needs of the user by adding additional pairs of side panels.

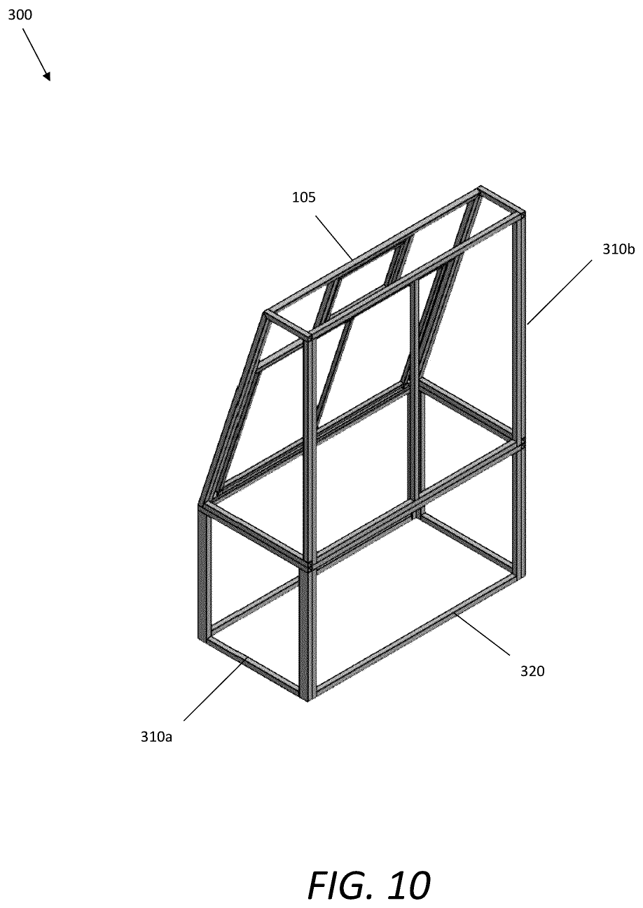

FIG. 10 shows a perspective view of a modular prefabricated raised bed greenhouse 300. Raised bed greenhouse 300 comprises a first side panel 105, a second side panel 320, a first end panel 310a, a second end panel 310b, and a roof panel. Side panel 105 is identical to the side panels of greenhouses 100 and 200. End panels 310a and 310b are identical to one another and are different than side panels 110a, 110b. Side panel 320 is different than side panel 105. Side panel 320 has a base frame and a top frame that form a planar surface. The planar surface is advantageous for placing raised bed greenhouse 300 against a flat structure such as a wall or fence. The length of raised bed greenhouse 300 can be extended by including additional pairs of side panels 105, 320 and an equal additional number of roof panels.

The inventive subject matter disclosed herein provides a modular raised bed greenhouse comprised of prefabricated side panels, end panels, and roof panels that can be easily assembled. The inventive subject matter also provides a modular prefabricated raised bed greenhouse that can be assembled in different lengths (e.g., 1×1, 1×2, 1×n).

As used herein, and unless the context dictates otherwise, the term “attached to” and “coupled to” are intended to include both direct coupling (in which two elements that are coupled to each other contact each other) and indirect coupling (in which at least one additional element is located between the two elements). Therefore, the terms “attached to,” “coupled to,” “attached with,” and “coupled with” are used synonymously.

Unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

It should be apparent to those skilled in the art that many more modifications besides those already described are possible without departing from the inventive concepts herein. The inventive subject matter, therefore, is not to be restricted except in the spirit of the amended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification refers to at least one of something selected from the group consisting of A, B, C . . . and N, the text should be interpreted as requiring only one element from the group, not A plus N, or B plus N, etc.

What is claimed is:

1. A modular prefabricated side panel for a raised bed greenhouse comprising:
a base frame that defines one or more open spaces covered by a transparent sheet;
a top frame that defines one or more open spaces covered by a transparent sheet;
wherein the base frame and the top frame are joined at an angle;
a door disposed in the top frame and transitionable between an open position and a closed position; and
one or more fasteners for adjacently coupling the modular prefabricated side panel with another modular prefabricated side panel or a modular prefabricated end panel.

2. The modular prefabricated side panel of claim 1, wherein the door is hingeably coupled with the top frame.

3. The modular prefabricated side panel of claim 1, wherein the door is slidably disposed in the top frame.

4. The modular prefabricated side panel of claim 1, wherein the angle between the base frame and the top frame is about 72 degrees.

5. The modular prefabricated side panel of claim 1, wherein the fastener is a mechanical fastener.

6. The modular prefabricated side panel of claim 1, wherein the top frame defines an uncovered open space.

7. The modular prefabricated side panel of claim 1, wherein the base frame and the top frame each comprise a plurality of tubing joined together to form the one or more open spaces.

8. The modular prefabricated side panel of claim 7, wherein the tubing is joined together by welding.

9. The modular prefabricated side panel of claim 1, wherein the side panel is stackable with identical side panels.

10. A modular prefabricated end panel for a raised bed greenhouse comprising:
a base frame that defines one or more open spaces covered by a transparent sheet;
a top frame that defines one or more open spaces covered by a transparent sheet;
wherein the base frame and the top frame form a planar surface; and
one or more fasteners for coupling the modular prefabricated end panel with a modular prefabricated side panel.

11. The modular prefabricated end panel of claim 10, wherein the one or more fasteners are configured to couple with the modular prefabricated side panel of claim 1.

12. A modular prefabricated raised bed greenhouse comprising:
a first side panel of claim 1 and a second side panel of claim 1 disposed on opposite sides of the modular prefabricated raised bed greenhouse;
a first end panel of claim 10 and a second end panel of claim 10 disposed on opposite sides of the modular prefabricated raised bed greenhouse;
wherein the first end panel is coupled with the first side panel and the second side panel;
wherein the second end panel is coupled with the first side panel and the second side panel; and
a roof panel coupled with the first side panel, the second side panel, the first end panel, and the second end panel.

13. A modular prefabricated raised bed greenhouse comprising:
one or more pairs of side panels of claim 1, wherein each side panel in a pair is disposed on an opposite side of the modular prefabricated raised bed greenhouse from the other side panel in the pair;
a first end panel of claim 10 and a second end panel of claim 10 disposed on opposite sides of the modular prefabricated raised bed greenhouse and coupled with a pair of side panels; and
a roof panel coupled with each of the one or more pairs of side panels.

14. A modular prefabricated raised bed greenhouse comprising:
a first side panel of claim 1;
a second side panel disposed on an opposite side of the modular prefabricated raised bed greenhouse from the first side panel;
wherein the second side panel is planar;
a first end panel and a second end panel disposed on opposite sides of the modular prefabricated raised bed greenhouse and coupled with the first side panel and the second side panel; and
a roof panel coupled with the first side panel, the second side panel, the first end panel, and the second end panel.
